(19) United States
(12) Patent Application Publication
(10) Pub. No.: US 2009/0223757 A1
(43) Pub. Date: Sep. 10, 2009

(54) UNDERCAR AIR MANAGEMENT SYSTEM

(76) Inventor: CLAUDIO R. BALLARD, HUNTINGTON, NY (US)

Correspondence Address: HOWISON & ARNOTT, L.L.P, P.O. BOX 741715, DALLAS, TX, 75374-1715, US

(21) Appl. No.: 12/396,152

(22) Filed: Mar. 2, 2009

Related U.S. Application Data
(60) Provisional application No. 61/034,805, filed on Mar. 7, 2008.

(51) Int. Cl. F16D 65/827; F16D 65/847

(52) U.S. Cl. 188/264 R; 165/44

(57) ABSTRACT

A vehicle including an under body air management system includes a frame having first and second parallel, longitudinally extending frame members, rear wheel brakes, first and second ducts adapted to be mounted on frame members of the vehicle, an air inlet fixture mounted on the first end of each of the ducts, the inlet fixtures configured to conduct air into the ducts, the inlet fixtures adapted for mounting toward the forward end of the car to receive air therethough as the car travels in a forward direction and an air outlet fixture mounted at a second end of each of the ducts, each of the outlet fixture configured to direct air from each of the ducts against rear wheel brakes of the vehicle.

### CROSS-REFERENCE TO RELATED APPLICATIONS

This application claims the benefit of U.S. Provisional Application for patent Ser. No. 61/034,805, filed Mar. 7, 2008, and entitled UNDERCAR AIR MANAGEMENT SYSTEM, the specification of which is incorporated herein in its entirety by reference.

### TECHNICAL FIELD

The following disclosure relates to an underbody air management system for a vehicle such as an automobile.

### BACKGROUND

Braking systems for automobiles and trucks can generate a significant amount of heat during operation. For example, in the case of disk-type brakes, when the brakes are applied, friction between the brake pads and the brake rotors can result in significant heating of the pads and rotors. If the heat is excessive, the brake components may be damaged or suffer significant wear. For example, if the rotors of a disk brake system overheat, the rotors may warp, rendering the brakes inoperable. This is especially true in the case of high performance automobiles. Thus, there exists a need for a system to manage the flow of air to brake components to facilitate cooling.

High performance vehicles also tend to require a relatively stiff frame to facilitate handling and performance of the vehicle. Further, the air flow under a vehicle tends to impart “lift” to the vehicle, reducing the frictional forces between the vehicles tires and the road. Thus, there exists a need for an air management system that provides a supply of cooling air to the vehicles brakes and further provides a means of stiffening the vehicle's frame and/or body.

### SUMMARY

In one aspect thereof, an under body air management system for a vehicle is disclosed. The air management system includes first and second ducts adapted to be mounted on parallel, longitudinally extending frame members of a vehicle, each of the ducts having first and second ends, a top wall, a bottom wall and a generally W-shaped stiffening member attached to the top and bottom walls and extending along the length of the ducts. An inlet fixture mounted on the first end of each of the ducts is configured to conduct air into the ducts. The inlet fixtures are adapted for mounting toward the forward end of the car to receive air therethough as the car travels in a forward direction. An outlet fixture is mounted to a second end of each of the ducts and configured to direct air from each of the ducts against rear wheel brakes of the vehicle. An electrically powered fan associated with each of the air inlet fixtures may be provided and configured to direct air into the inlet fixture.

In another aspect, a vehicle including an under body air management system includes a frame having first and second parallel, longitudinally extending frame members, rear wheel brakes and first and second ducts adapted to be mounted on parallel, longitudinally extending frame members of the vehicle. Each of the ducts has first and second ends, a top wall, a bottom wall and a stiffening member attached to the top and bottom walls and extending along the length of the ducts. In one embodiment, the top and bottom walls of the ducts extend from the stiffening member to form a C-shaped channel wherein a frame member of the vehicle is received.

In one variation, an air inlet fixture is mounted on the first end of each of the ducts. The air inlet fixtures are configured to conduct air into the ducts and adapted for mounting toward the forward end of the car to receive air as the car travels in a forward direction. Air outlet fixtures mounted at the second end of each of the ducts direct air from the ducts against rear wheel brakes of the vehicle. In one embodiment, each of the air outlet and air inlet fixtures form a C-shaped channel wherein a frame member of the vehicle is received.

### BRIEF DESCRIPTION OF THE DRAWINGS

For a more complete understanding, reference is now made to the following description taken in conjunction with the accompanying Drawings in which:

FIGS. 1, 2 and 3 illustrate side, front and rear views, respectively, of a two seat roadster style automobile;

FIG. 4 is a schematic representation of air management system of the present disclosure;

FIG. 5 is a perspective view of left and right ducts of the air management system of FIG. 4;

FIG. 6 is a perspective view of the inlets and outlets of the air management system of FIG. 4; and

FIG. 7 is a partial cross-sectional view illustrating the position of the ducts of the air management system of FIG. 4.

### DETAILED DESCRIPTION

Referring now to the drawings, wherein like reference numbers are used herein to designate like elements throughout, the various views and embodiments of an undercar air management system. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

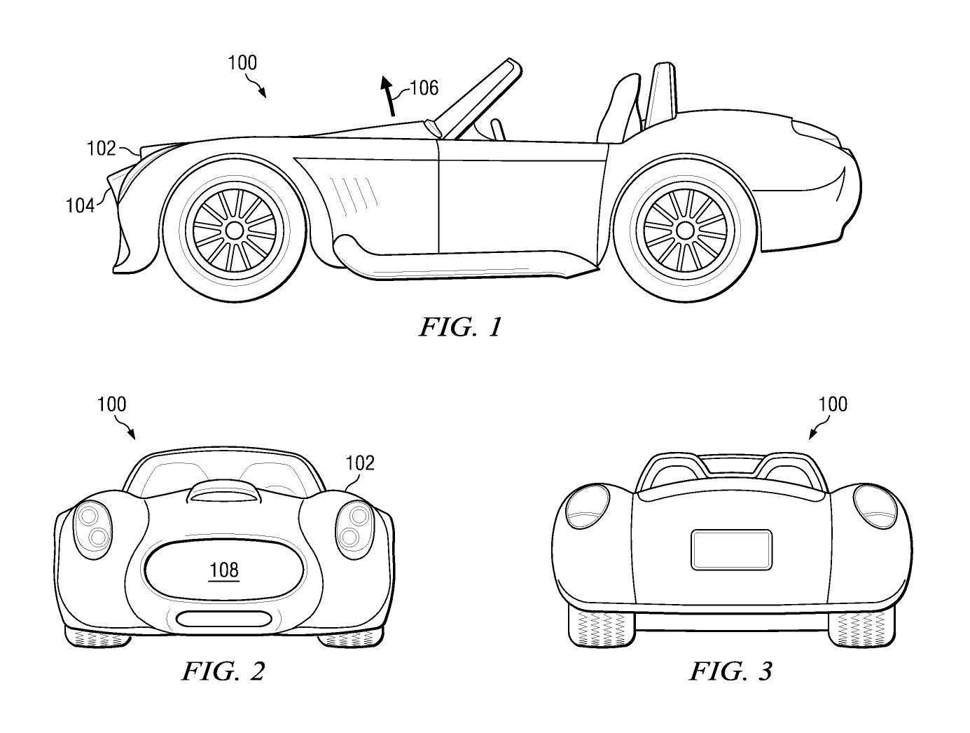

FIGS. 1, 2 and 3 are side, front and rear views, respectively, of a two seat roadster style automobile 100 employing the under body air management system of the present disclosure. Automobile 100 includes a nose 102 having a forward end 104. Nose 102 opens in the direction indicated by arrow 106, pivoting around forward end 104. As best shown in FIG. 2, nose 104 includes a central opening 108 that receives air therethrough when vehicle 100 is traveling in the forward direction.

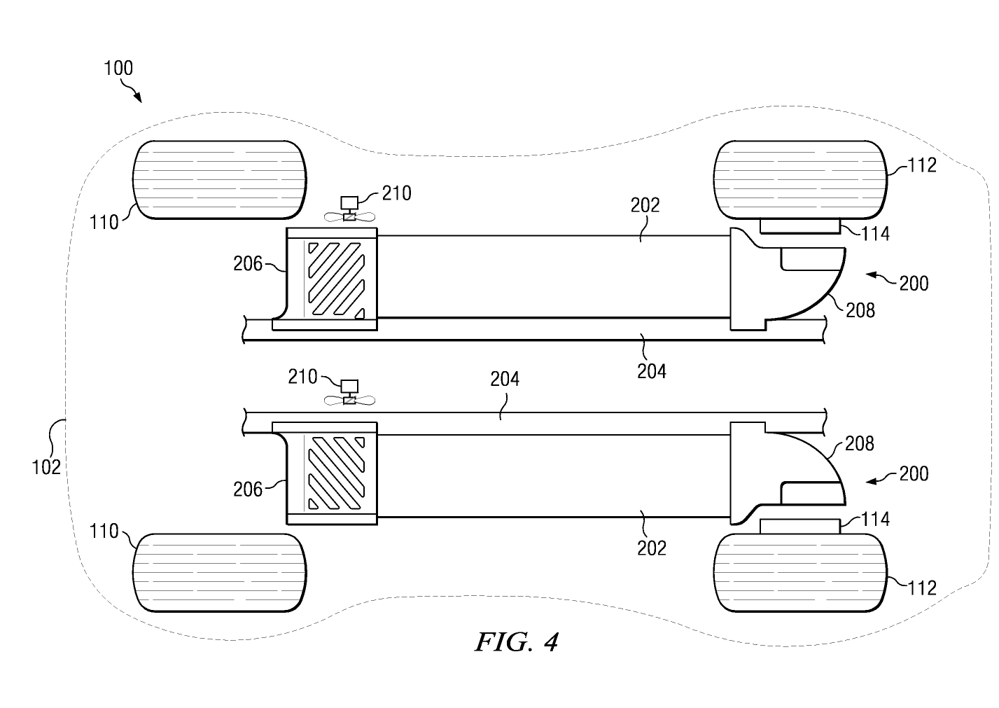

FIG. 4 is a schematic representation of air management system 200. Automobile 100 includes front tires 110 and rear tires 112. Each of rear tires 112 has a brake assembly 114 associated therewith. In one embodiment, brake assemblies 114 comprise disc-type brakes. Air management system 200 includes a pair of longitudinally extending ducts 202 adapted to be mounted on frame members 204 of vehicle 100. An air inlet fixture 206 is mounted on a forward end of each of ducts 202. An air outlet fixture 208 is mounted on a rear end of each of ducts 202. In one embodiment, air inlet fixtures 206 are positioned adjacent front wheels 110. Air outlet fixtures 208 are positioned at the rear end of ducts 202 and configured to direct air from the ducts onto brake assemblies 114. In one embodiment, an electrically operated fan 210 is configured to direct air into air inlet fixtures 206. Fan 210 may be mounted on, inside or adjacent to air inlet fixtures 206 so long as the fan is positioned to direct air into the inlet.

In one embodiment, fan 210 is controlled such that the fan is actuated only when vehicle 100 is stopped or traveling at a low rate of speed. When the vehicle accelerates to a predetermined speed, fan 210 is de-energized.

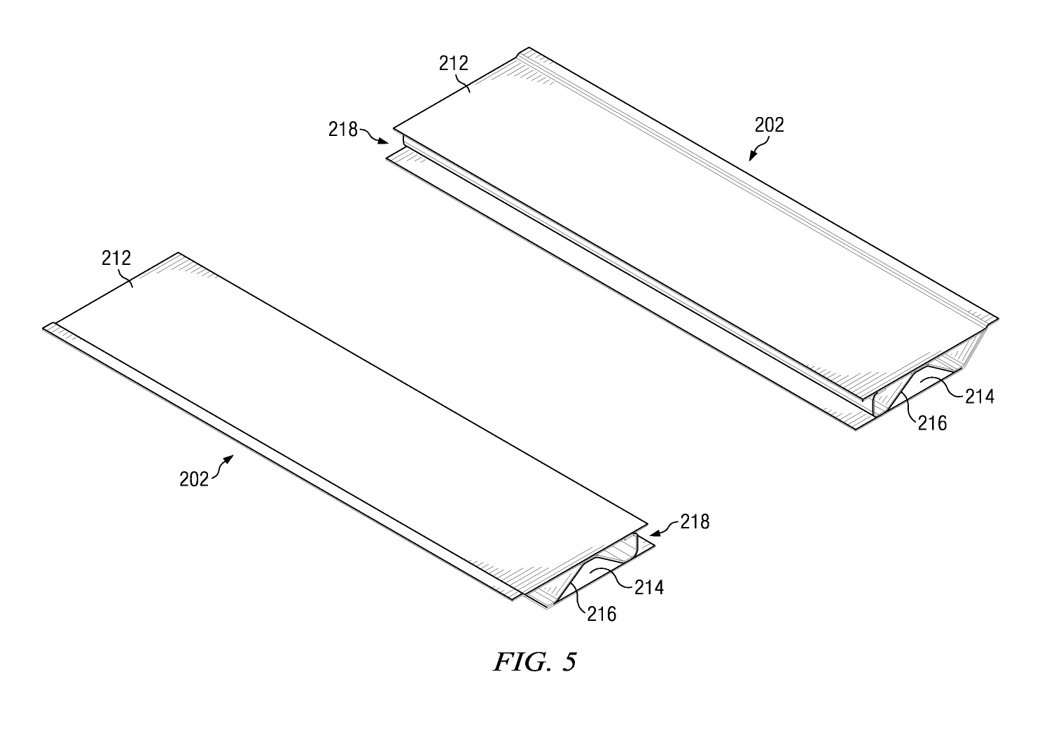

FIG. 5 is a perspective view of left and right ducts 202 of air management system 200. Each of ducts 202 includes a top wall 212, a bottom wall 214 and a generally W-shaped stiffening member 216 extending between the top and bottom walls. In one embodiment, top wall 212, bottom wall 214 and W-shaped stiffening member 216 are each formed from aluminum sheet. Top wall 212, bottom wall 214 and W-shaped stiffening member 216 may be assembled by means of welding, fasteners such as rivets or screws and/or by means of adhesives. In one embodiment, top and bottom walls 214 extend outward from W-shaped stiffening member 216 to form a C-shaped channel or opening 218 wherein frame member 204 (FIG. 4) of automobile 100 is received. Ducts 202 may be fastened to frame members 204 by means of mechanical fasteners such as screws or rivets, by means of welding, or by means of appropriate adhesives. In other embodiments, ducts 202 may have different geometries with or without stiffener and may be formed from different materials such as carbon fiber composites, steel, plastic or fiber glass.

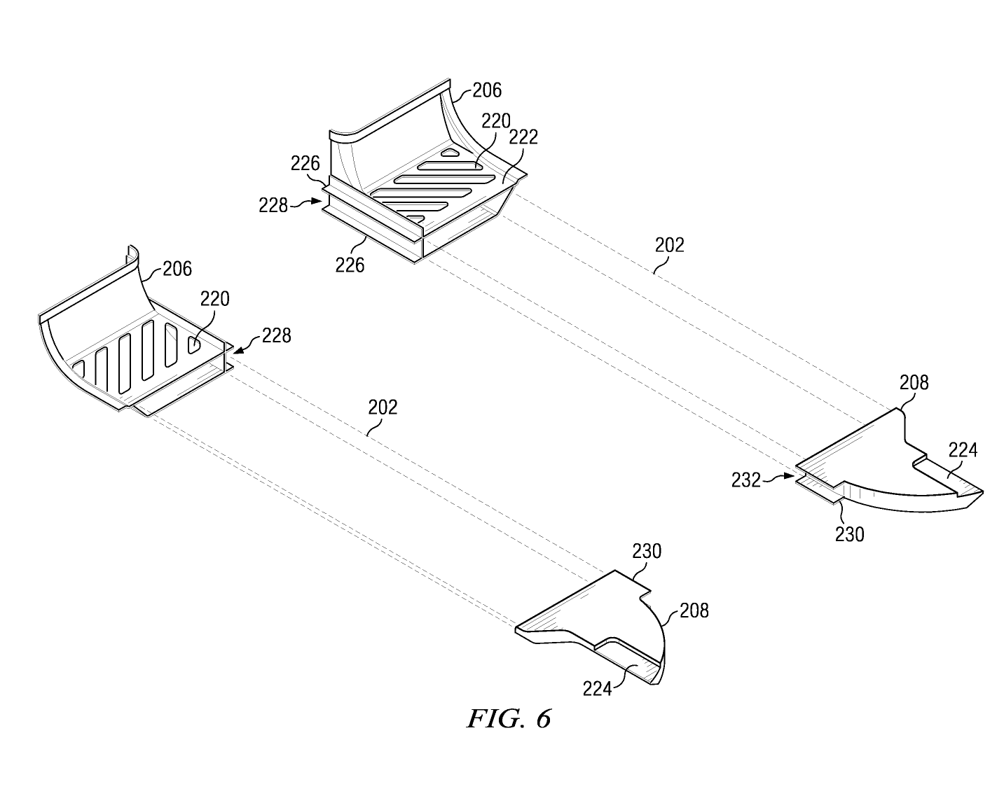

FIG. 6 is a perspective view of inlet fixtures 206 and outlet fixtures 208 of air management system 200, with duct 202 shown in phantom for purposes of illustration. As shown, air inlet fixtures 206 include a plurality of slots 220 formed in an upper wall 222 of the air inlet. Slots 220 allow air to pass into air inlet fixtures 206 and through ducts 202 to outlet fixtures 208. Each of outlet fixtures 208 has a side opening 224 configured to direct air from ducts 202 through the outlet fixture and onto a brake assembly 114 (FIG. 4) of automobile 100. In one embodiment, air inlet fixtures 206 are formed from cast aluminum and include side runners or extensions 226 that form a C-shaped channel 228 wherein a frame member 204 (FIG. 4) of automobile 100 is received. Similarly, outlet fixtures 208 include side members or extensions 230 that form a channel 232 wherein a frame member 204 is received and may be bonded to the air outlet fixture. In one embodiment, air outlet fixtures 208 are fabricated from carbon fiber composite materials. In other embodiments, fixtures may be formed from a metal such as aluminum, plastic or fiberglass.

As will be appreciated, ducts 202 serve as frame stiffeners for vehicle 100. Hence, the weight and strength of frame members 204 may be reduced accordingly.

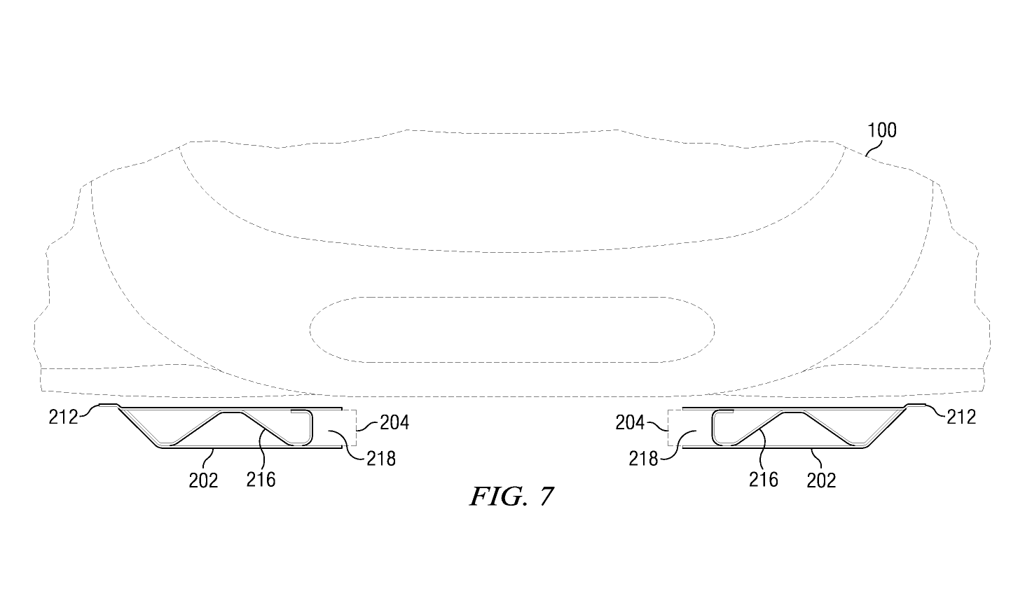

FIG. 7 is a partial cross-sectional view illustrating the position of ducts 202 of air management system 200. As shown, ducts 202 are positioned over frame members 204 with the frame member at least partially in C-shaped opening or channel or 218. Ducts 202 may be attached to frame members 204 by means of mechanical fasteners such as screws or rivets, by welding or by means of appropriate adhesives. In one embodiment, a combination of mechanical fasteners and adhesives are used. In this embodiment, the mechanical fasteners are provided to hold the ducts 202 onto the frame members 204 until the adhesives cure.

It will be appreciated by those skilled in the art having the benefit of this disclosure provides an undercar air management system. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. An under body air management system for a vehicle comprising:
first and second ducts adapted to be mounted on parallel, longitudinally extending frame members of a vehicle, each of the ducts having first and second ends, a top wall, a bottom wall;
an air inlet fixture mounted on the first end of each of the ducts, the inlet fixtures configured to conduct air into the ducts, the inlet fixtures adapted for mounting toward the forward end of the vehicle to receive air therethough as the vehicle travels in a forward direction; and
an air outlet fixture mounted at a second end of each of the ducts, each of the outlet fixture configured to direct air from each of the ducts against rear wheel brakes of the vehicle.

2. The under body air management system of claim 1 further comprising a stiffening member attached to the top and bottom walls of the ducts and extending along the length of the ducts.

3. The under body air management system of claim 1 further comprising a generally W shaped stiffening member attached to the top and bottom walls of the ducts and extending along the length of the ducts.

4. The under body air management system of claim 1 further comprising an electrically powered fan associated with each of the air inlet fixtures and configured to direct air into the inlet fixture.

5. The under body air management system of claim 1 wherein the air inlet fixtures form a channel wherein a frame member of the vehicle is received.

6. The under body air management system of claim 1 wherein the air inlet fixtures extensions form a C-shaped channel wherein a frame member of the vehicle is received.

7. The under body air management system of claim 1 wherein the air outlet fixtures form a channel wherein a frame member of the vehicle is received.

8. The under body air management system of claim 1 wherein the air outlet fixtures form a C-shaped channel wherein a frame member of the vehicle is received.

9. An under body air management system for a vehicle comprising:
first and second ducts adapted to be mounted on the parallel, longitudinally extending frame members of the vehicle, each of the ducts having first and second ends, a top wall, a bottom wall and a stiffening member attached to the top and bottom walls and extending along the length of the ducts, each of the ducts further including a channel wherein one of the frame members of the vehicle is received;
an air inlet fixture mounted on the first end of each of the ducts, the inlet fixtures configured to conduct air into the ducts, the inlet fixtures adapted for mounting adjacent the forward end of the vehicle to receive air therethough as the vehicle travels in a forward direction; and
an air outlet fixture mounted at a second end of each of the ducts, each of the outlet fixture configured to direct air from each of the ducts against the rear wheel brakes of the vehicle.

10. The under body air management system of claim 9 further comprising an electrically powered fan associated with each of the air inlet fixtures and configured to direct air into the inlet fixture.

11. The under body air management system of claim 9 wherein the stiffening member is generally W shaped.

12. The under body air management system of claim 9 wherein the channel for receiving a frame member of the vehicle is generally C-shaped.

13. The under body air management system of claim 9 wherein the outlet fixtures have a side opening configured to direct air from the ducts through the outlet fixture and onto a brake assembly of the vehicle.

14. The under body air management system of claim 9 wherein each of the air outlet and air inlet fixtures form a channel wherein a frame member of the vehicle is received.

15. The under body air management system of claim 9 wherein each of the air outlet and air inlet fixtures form a C-shaped channel wherein a frame member of the vehicle is received.

16. A vehicle including an under body air management system comprising:
a frame having first and second parallel, longitudinally extending frame members;
rear wheel brakes;
first and second ducts adapted to be mounted on parallel, longitudinally extending frame members of the vehicle, each of the ducts having first and second ends, a top wall, a bottom wall and a stiffening member attached to the top and bottom walls and extending along the length of the ducts, the top and bottom walls of the ducts extending from the stiffening member to form a channel wherein a frame member of the vehicle is received;
an air inlet fixture mounted on the first end of each of the ducts, the inlet fixtures configured to conduct air into the ducts, the inlet fixtures adapted for mounting toward the forward end of the car to receive air therethough as the car travels in a forward direction; and
an air outlet fixture mounted at a second end of each of the ducts, each of the outlet fixture configured to direct air from each of the ducts against rear wheel brakes of the vehicle.

17. The vehicle of claim 16 further comprising an electrically powered fan associated with each of the air inlet fixtures and configured to direct air into the inlet fixture.

18. The vehicle of claim 16 wherein the stiffening member is generally W shaped and wherein the top and bottom walls of the ducts extend to for a C-shaped channel for receiving a frame member of the vehicle.

19. The vehicle of claim 16 wherein the outlet fixtures have a side opening configured to direct air from the ducts through the outlet fixture and onto a brake assembly of the vehicle.

20. The vehicle of claim 16 wherein each of the air outlet and air inlet fixtures form a C-shaped channel wherein a frame member of the vehicle is received.
